(19) United States
(12) Patent Application Publication
(10) Pub. No.: US 2026/0257715 A1
(43) Pub. Date: Sep. 3, 2026

(54) FOLDABLE FRAME FOR PRAM

(71) Applicant: CYBEX GmbH, Bayreuth (DE)

(72) Inventor: Gabriel ALTENHOFEN, Bayreuth (DE)

(21) Appl. No.: 19/165,456

(22) PCT Filed: Mar. 13, 2024
(86) PCT No.: PCT/EP2024/056644

§ 371 Date: Sep. 15, 2025

(30) Foreign Application Priority Data
Mar. 17, 2023 (DE) 20 2023 101 348.1

(51) Int. Cl. B62B 7/06; B62B 9/10

(52) U.S. Cl. CPC B62B 7/06; B62B 9/102; B62B 2205/24

(57) ABSTRACT

Pram frame (10) comprising: a first frame element (1), a second frame element (2), a third frame element (3) and a pull element (4),
wherein the first, second and third frame elements (1, 2, 3) are rotatably connected to each other and can be transferred between a usage position and a storage position by rotation,
wherein, during the transfer from the storage position to the usage position, the first frame element (1) is moved relative to the third frame element (3) in a first direction and sweeps over a first angular range, and the second frame element (2) is also moved relative to the third frame element (3) in the first direction and sweeps over a second angular range, wherein the second angular range preferably is smaller than the first angular range,
characterised in that the first frame element (1) and the second frame element (2) are connected to each other by the pull element (4) and the first frame element (1) drives the second frame element (2) via the pull element (4) to move in the first direction when the first frame element (1) has reached or exceeded a dead angle (LW) relative to the second frame element (2).

A plurality of pram frames that can be connected to a child seat are known. The pram frames are either permanently connected to the child seat or are, when needed, detachably connected therewith.

However, pram frames are not used all the time and must be temporarily stored for the time of non-use. In the non-use state a pram frame, and if possible an associated seat, should take up as little space as possible so that it can be stored in a space-saving manner. For this purpose, a pram frame or pram can often be collapsed.

Disadvantageous of previously known collapsible prams is that the collapsing and unfolding is very complicated and technically complex. In particular, for unfolding the pram a plurality of steps is required to move the child seat from the collapsed state (storage position) to the unfolded state (usage position). The plurality of steps for unfolding are often difficult to remember, unintuitive and mechanically complicated to perform. There is also a considerable risk of injury with hitherto known collapsible prams, in particular from fingers and/or hands getting caught when unfolding (or also when collapsing) the pram. Hitherto known collapsible prams are also technically complex in design.

There is therefore a fundamental need for prams that can be easily transferred from a storage position to a usage position, in particular without requiring a plurality of steps or tools.

Systems that should make unfolding easier are currently known, but they require end stops that are difficult to construct and synchronised coupling systems in one or several joints, which are formed by frame elements of the pram frame.

For example, CN 103523068 B discloses a pram frame in which the push section and the front wheel strut each have a gear wheel component within a joint, which interact to synchronise the movement of the push section with the front wheel strut. However, this has the disadvantage that many components are required and the gear wheels are subject to high stress and therefore have to be manufactured at high cost, which increases the overall manufacturing costs. In addition, the gear wheels wear out, which causes a disruption in the smooth synchronisation.

It is therefore the object of the present invention to reduce or eliminate at least one of the aforementioned disadvantages and to provide a simple, robust, safe and cost-effective solution, in particular a solution in which the unfolding or swinging out of a pram frame is made possible in a single, simple and continuous movement by the user.

The task is solved by a pram frame according to claim 1, as well as a method according to claim 14.

In particular, the object is solved by a pram frame comprising a first frame element, a second frame element, a third frame element and a pull element, wherein the first, second and third frame elements are rotatably connected to each other and can be transferred between a usage position and a storage position by rotation, wherein, during the transfer from the storage position to the usage position, the first frame element is moved relative to the third frame element in a first direction and sweeps over a first angular range, and the second frame element is moved relative to the third frame element also in the first direction and sweeps over a second angular range, wherein the second angular range is preferably smaller than the first angular range,
characterised in that the first frame element and the second frame element are connected to each other by the pull element and the first frame element drives the second frame element via the pull element to move in the first direction when the first frame element has reached or exceeded a dead angle relative to the second frame element.

In particular, the object according to the invention is solved by a pram frame comprising: a first frame element, a second frame element, a third frame element and a pull element, wherein the first, second and third frame elements are rotatably connected to each other and can be moved from a usage position to a storage position by rotation, wherein, during the transfer from the storage position to the usage position, the first frame element is moved relative to the third frame element in a first direction and sweeps over a first angular range, and the second frame element is moved relative to the third frame element also in the first direction and sweeps over a second angular range, wherein the second angular range is smaller than the first angular range, wherein the first angular range is defined in particular as the region in which a first angle can lie during the transfer between the storage position and the usage position, and wherein the second angular range is defined in particular as the region in which a second angle can lie during the transfer between the storage position and the usage position. In particular, the first angle indicates the angle in the first direction between a third direction of extension of the third frame element and a first direction of extension of the first frame element around the point of intersection of the first and third directions of extension in a plane that is perpendicular to one or several axes about which the third frame element is rotatably connected to another frame element, and the second angle indicates, in particular, the angle in the first direction between the third direction of extension of the third frame element and a second direction of extension of the second frame element around the point of intersection of the second and third directions of extension in a plane that is perpendicular to one or several axes about which the third frame element is rotatably connected to another frame element. Furthermore, the first frame element and the second frame element are connected to each other by the pull element, and the first frame element drives the second frame element via the pull element to move in the first direction when the first frame element has reached or exceeded a dead angle relative to the second frame element.

The first direction, in this, describes a direction which at least essentially indicates the direction of movement of the first frame element when it is moved out of the storage position or unfolded.

The first and second angles are determined by the angle specified by the first and second directions of extension in conjunction with the third direction of extension. In this, the angle is determined in such a way that the angle between a line that is parallel to the third direction of extension and a line that is parallel to the first or second direction of extension is determined around the point of intersection of the two lines, starting from the third direction of extension in the first direction.

The direction of extension of a frame element is preferably the direction in which the respective frame element essentially extends. A direction of extension can be defined by the two points of the frame element that are furthest apart. Alternatively or additionally, the respective direction of extension can be the direction defined by the longest possible distance within the frame element.

Reaching (or exceeding) a dead angle can be understood to mean that during the transfer from the storage position to the usage position, the angle between the first frame element and the second frame element reaches or exceeds the dead angle (so that the first frame element can drive the second frame element via the pull element) after the angle between the first frame element and the second frame element was initially smaller than the dead angle (so that the first frame element could not drive the second frame element via the pull element).

Exceeding the dead angle may be possible in particular if the pull element has a certain elasticity, so that its length can change (reversibly) under tensile load.

Shortly after leaving the storage position for transfer to the usage position (preferably also in the storage position itself), the second frame element is arranged between the first and third frame elements (meaning in a view looking in the direction of at least one of the axes, i.e. typically a side view). Shortly after leaving may mean, for example, that each of the elements has swept over a maximum of 10° or a maximum of 5° since leaving the storage position. For example, at least two of the frame elements may also lie directly on top of each other in the storage position itself.

When transferring the pram frame from the storage position to the usage position, the first frame element is moved or rotated relative to the third frame element in a first direction, in particular away from the second frame element, and sweeps over a first angular range.

When the first frame element has reached (or, if applicable, exceeded) a predetermined angle relative to the second frame element, the upper dead angle, the first frame element drives the second frame element via the pull element to move in the first direction, or the first frame element pulls the second frame element in the first direction, so that the second frame element sweeps over the second angular range (or is assisted in doing so).

In this, the pram frame comprises at least one (first) axis of rotation between at least two of the first, second and third frame elements.

A storage position is understood to be, in particular, a position in which the pram frame is at least essentially folded up, and a usage position is understood to be, in particular, a position in which the pram frame is at least essentially unfolded.

It may be that the second frame element already moves away from the third frame element due to the effect of gravity or the pressure of compressed soft goods or similar, without necessarily reaching the position of the second frame element corresponding to the usage position.

It may be provided that the first frame element does not drive the second frame element to the complete reaching of the usage position, but only to a position from which the dead weight of the pram frame or a force applied from outside for pushing acts on the frame elements in such a way that they are driven further to move into the usage position (for example, when the pram frame is supported by the wheels).

The invention is based on the idea of utilising the joint mounting of the frame elements to couple the second frame element to the first frame element in such a way that only the first frame element (in particular relative to the third frame element) needs to be moved in order to unfold the pram frame. At the same time, the effect just described can be achieved with a delay by the dead angle, which enables a less strenuous and more continuous movement when unfolding the pram frame.

The first frame element can preferably be a push section, the second frame element preferably a rear wheel strut, and the third frame element preferably a front wheel strut.

In a preferred embodiment, the pull element is connected at a first end to the first frame element at a first connection point and at a second end to the second frame element at a second connection point.

An attachment of the pull element at the respective ends is advantageous in this because by this in an easy manner a dead angle can be determined from the length of the pull element (as well as the position of the connection points and, if applicable, other geometric features of the pram frame). In particular, attachment at only two contact points is also simpler and more cost-effective than more complicated attachments.

In this, it is further preferred that the pull element is designed to be dimensionally unstable, preferably as a strap, belt, chain or cord. Dimensionally unstable means in particular that the pull element is reversibly bendable and/or foldable and/or rollable. A thickness (in particular the minimum extension transverse to the direction of extension) of the pull element is preferably at most 5 mm, more preferably at most 2 mm or at most 1 mm.

Due to its dimensionally unstable design, the pull element allows easy collapsing or transfer to the storage position, as it offers no (at least no significant) resistance when the first frame element and the second frame element are brought close to each other. Instead, the use of such a pull element allows automatic folding up and/or evasion of the pull element. In addition, the specified means are both easy to attach as well as inexpensive to manufacture, which means that they can be easily replaced should signs of wear and tear make this necessary.

According to a further preferred embodiment, the dead angle can be adjusted or changed by the adjustment and/or change of a length of the pull element and/or the first and/or second connection point, in particular during the transfer between the storage position and the usage position. Preferably by means of a sliding attachment at the first and/or second connection point.

The connection of the pull element to the respective frame elements can be a fixed connection and/or a movable, in particular sliding, connection; preferably, each of the ends of the pull element is either fixed or (slidingly) movable, further preferably, one end is fixed and the other end is (slidingly) movable connected to the respective frame elements.

A fixed connection shall be defined by a constant connection point of the pull element to the associated frame element, in particular one that is stationary in relation to the frame element, whereby rotation around the connection point may still be possible.

A fixed connection may, for example, comprise a detachable, in particular tool-free and/or non-destructively detachable, and/or non-detachable connection between the pull element and the associated frame element, in particular a riveting.

A movable, in particular slidingly movable, connection shall be defined by a connection point of the pull element which can move within a certain region of the associated frame element; preferably, the connection point can be located relatively close (e.g. at a distance of at least 1 cm, preferably at least 4 cm and/or at most 14 cm, preferably at most 10 cm) to the first or second axis of rotation and, in the storage position, slide between the position which is relatively close with respect to the first or second axis of rotation (e.g. at a distance of at least 1 cm, preferably at least 4 cm and/or at most 14 cm, preferably at most 10 cm) and a more distant position (e.g. at a distance of at least 2 cm, preferably at least 6 cm and/or at most 18 cm, preferably at most 12 cm) (whereby the possibility of sliding is increasingly reduced during the transfer from the storage position to the usage position).

Similar to the fixed connection, a (slidingly) movable connection may comprise a detachable and/or non-detachable connection between the pull element and the associated frame element.

A detachable connection may, for example, be designed as a buckle connection.

A non-detachable connection may, for example, be designed as a rivet or screw connection, but also as a webbing loop.

A (slidingly) movable connection can, for example, be designed as a loop (e.g. formed by the pull strap itself, in particular by sewing it to itself) or as a ring or by means of a sliding member (for sliding in a guide formed in the corresponding frame element) or similar.

The connection points of the pull element may be spaced apart from a first and/or second axis of rotation, preferably by at least 1 cm or at least 3 cm (whereby the connection point may, for example, abut against a housing of the joint), and/or by a maximum of 30 cm, preferably a maximum of 15 cm.

The minimum and/or maximum distance of the connection point to the first or second axis of the frame elements can also be set in the case of a slidingly movable connection, for example by means of a stop element.

The length of the pull element can be between 5 cm and 35 cm, preferably 10 cm to 25 cm, further preferably 15 cm to 20 cm.

A slidingly movable attachment is to be understood as an attachment in which a connection point can be moved along an direction of extension of the frame element. For example, rails that fix a connection point by snapping into place are suitable for this purpose. However, simple loops that are placed around the respective frame element and can thus move along the direction of extension are also slidingly movable in the sense of this application. In this it is possible to prevent a slipping along the direction of extension of the frame element by fixing (for example, by means of at least one snap-in device and/or at least one cam and/or at least one hook, or similar).

In a further preferred embodiment, the pram frame has a first joint at one end of the third frame element, whereby the first and/or second frame elements are connected to the third frame element rotatable around the first joint.

By coupling the frame elements by means of at least one joint, a rotatable connection between the frame elements can be achieved. An embodiment with a joint is also particularly simple and requires a minimum number of components. The resulting geometry is also particularly simple, which makes it easy to transfer the pram frame from a storage position to a usage position. ‘At one end’ is to be understood in particular as meaning that the joint closest to a distal end of the third frame element is always to be understood as the first joint.

A joint is to be understood as any attachment/bearing that allows a rotation of the frame elements relative to each other about an axis.

According to a further preferred embodiment, the frame has a second joint which is attached to the first, second or third frame element in order to connect the first and second or second and third or first and third frame elements to each other in a rotatable manner, whereby the axis of rotation is parallel to the axis of rotation of the first joint.

By using a second joint, not all frame elements rotate around the same axis. By the resulting offset between the first and second joints an interspace can be created in the storage position, which allows the frame to be stowed in a more compact form. Especially when, as is usually the case, additional elements (such as a bag or a child accommodation unit) are attached to the frame elements, this arrangement allows the pram frame to be folded up into a more compact shape, as the additional elements do not block each other or the frame elements.

The first, second and third frame elements are always connected to each other rotatable about at least one axis. In embodiments with two joints, one of the frame elements can be rotatably connected to one of the other two frame elements via a first axis and to the other of the other two frame elements via a second axis parallel to the first axis, while the other two frame elements do not have to be directly connected to each other.

According to a further aspect, the frame can be locked in the usage position and/or storage position, Preferably, this is achieved by means of at least one first locking element within the first and/or second joint, wherein the at least one first locking element can be spring-loaded and is preferably in direct or indirect operative connection with an unlocking device.

As a rule, the pram frame is either in use or kept ready for use, or it is in the storage position. In the usage position, unintentional twisting of the frame elements against each other should be avoided in order to increase safety as well as comfort. In this respect, it is advantageous if the pram frame can be locked in the usage position to prevent unintentional twisting or collapsing of the frame elements.

Also, in a storage position it is preferable for the pram frame to be locked. This prevents the pram frame from unfolding unintentionally and, in particular, ensures that the pram frame remains in the storage position. This avoids unnecessary space consumption due to an incompletely folded pram frame. In addition, the handling of the pram frame in the storage position is also simplified, as unwanted folding movements are prevented.

For example, the storage position can also be locked by the first locking element or by a second (additional) locking element, e.g. by a hook preloaded into a locked position on one of the frame elements and, possibly, a projection on another one of the frame elements into which the hook can engage. The frame may comprise a first unlocking device for releasing the locking of the usage position and/or storage position, which may preferably be arranged on the first frame element, in particular on the pusher section.

An additional second unlocking device, in particular independent of the first unlocking device, may also be provided in order to release the locking of the second locking element; for example, the hook may be temporarily transferred into an unlocking position by actuating the second unlocking device.

In particular, it may be provided that the second locking element acts like a leaf spring and has a ramp and an engagement section, in particular hooks, at a distal end. When the storage position is reached, the other frame element can bend the engagement section along the ramp against the force of the leaf spring until the engagement section can be brought into engagement with the frame element (or, if applicable, the projection located thereon) by the force of the leaf spring. The unlocking can then be effected by manually bending the second locking element.

The first frame element, in particular the pusher section, can preferably comprise a proximal and a distal section, wherein the proximal section of the first frame element, in particular the pusher section, can be connected at one end in a rotatable and/or displaceable manner to the distal section (for length or height adjustment) and at the other end rotatably connected to the second and/or third frame element.

In one embodiment, the second frame element may be arranged between the third frame element and the first frame element, in particular the proximal section of the first frame element, in the storage position (or at least shortly after leaving it).

In a further embodiment, the locking is automatically triggered upon reaching the usage position and/or storage position.

Automatic triggering in turn simplifies the use, as fewer steps are required to bring the pram frame into a storage and/or usage position. This enables easier and safer handling.

In a further preferred embodiment, at least the first and/or second and/or third frame element is selected from a front wheel strut, rear wheel strut and pusher section, wherein these are preferably selected differently in pairs.

By a selection of the frame elements from the list of elements mentioned above the overall construction of the pram frame simplifies, as unnecessary intermediate elements can be dispensed with.

In a further embodiment, the pram frame comprises a child accommodation unit comprising a back section and a buttock section, wherein the back section is preferably rotatably connected to the buttock section and/or rotatably arranged relative to the buttock section, wherein the surfaces of the back section and the buttock section which come into contact with the child preferably abut against each other or face each other in the storage position, in particular at an angle between the surfaces of at least 2°, but at maximum 50°.

In one embodiment, the child accommodation unit may be integrally formed with the pram frame.

In one embodiment, the child accommodation unit can be detachably, in particular without tools and/or without causing damage, connected to the pram frame, e.g. via at least one adapter. The child accommodation unit can assume a storage position and a usage position which is not necessarily identical to the storage/usage position of the pram frame.

By a connection of the child accommodation unit to the pram frame assembly and disassembly, in turn, simplify. Because the surfaces oppose each other, the storage position is more compact overall. In particular, this ensures that the pram frame is compact enough also in the storage position for easy transport, easy storage or handling.

In a further embodiment, the child accommodation unit is connected to the pram frame in such a way that the child accommodation unit is transferred from the usage position to the storage position at the same time as the pram frame.

Thus, by a transfer to the usage position, a ready-to-use pram can be provided in a simple manner without having to adjust the child accommodation unit separately. It may also be advantageous in this to detachably attach the child accommodation unit to the pram frame so that it can be removed if necessary.

In a further embodiment, the surfaces of the back section and buttock section that do not come into contact with the child can preferably lie against each other or face each other, in particular at an angle between the surfaces of at least 2° but at maximum 50°.

In one embodiment, the child accommodation unit can be transferred individually, in particular independently of the pram frame, from the storage position to a usage position (and vice versa); preferably, the transfer of the child accommodation unit can be possibly before and/or after the transfer of the pram frame, more preferably, the child accommodation unit has to be already be in a storage position before the pram frame can be transferred from the usage position to the storage position.

In a further embodiment, the child accommodation unit may be connected to the pram frame in such a way that the child accommodation unit can be transferred from the usage position to the storage position (and vice versa) at the same time as the pram frame.

In some embodiments, the second angle during the transfer from the storage position to the usage position by rotating and/or swivelling the first frame element may be at least 0.2 times and/or at most 0.8 times the first angle, preferably at least 0.3 times and/or at most 0.7 times, more preferably at least 0.4 times and/or at most 0.6 times. This ensures that sufficient compactness is provided and, at the same time, that there is sufficient scope for movement of the frame elements relative to each other.

Further preferably, the first angle of the pram frame can preferably be 140°-220°, preferably 160°-200°, more preferably 110°-240°, in particular 170°-190°.

The corresponding angles enable an ergonomic geometry in a usage position through a suitable arrangement of the frame elements relative to each other.

A further aspect of the invention comprises a method for transferring a pram frame from a storage position to a usage position according to claim 1, wherein the first frame element is rotated and/or tilted relative to the third frame element, wherein, after reaching (or, if applicable, exceeding) the dead angle between the first and second frame elements (in particular by the first angle), the second frame element is pulled in the first direction via the pull element.

With the method according to the invention the same advantages can be achieved as have already been described in connection with the pram frame according to the invention. It should be noted that the features described in connection with the pram frame according to the invention preferably apply to the method according to the invention for unfolding a pram frame. Likewise, features of the method according to the invention are transferable to the pram frame according to the invention by configuring the pram frame in such a way that it is suitable for performing the corresponding method features.

The invention is described below with regard to further details, features and advantages, which are explained in more detail with reference to the figures. The features and combinations of features described, as shown in the figures of the drawing below and described with reference to the drawing, are not only applicable in the combination specified in each case, but also in other combinations or on their own, without departing from the scope of the invention.

Hereby show:

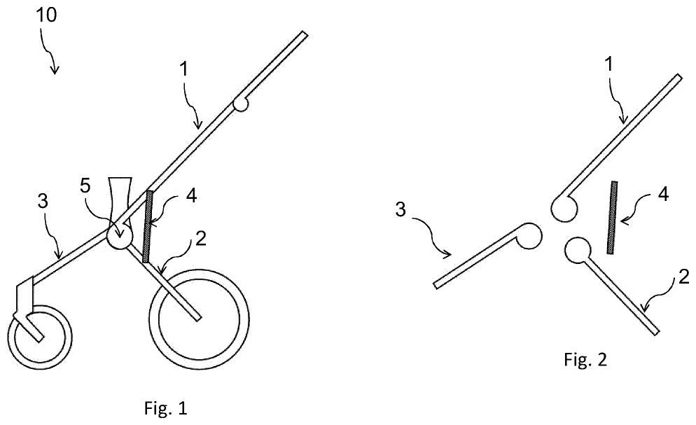

FIG. 1 a pram frame

FIG. 2 components of a pram frame

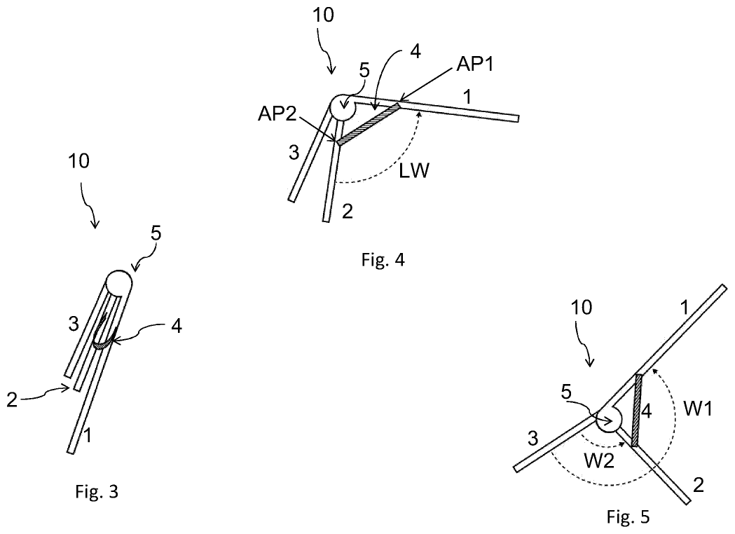

FIG. 3-FIG. 5 a first embodiment with a joint

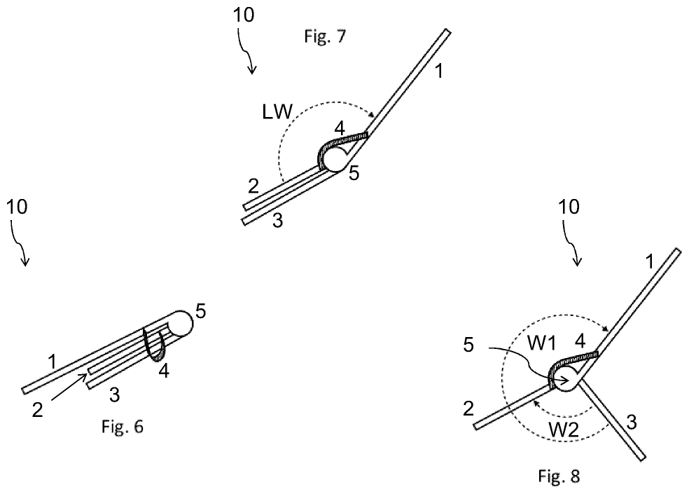

FIG. 6-FIG. 8 a further embodiment with a joint

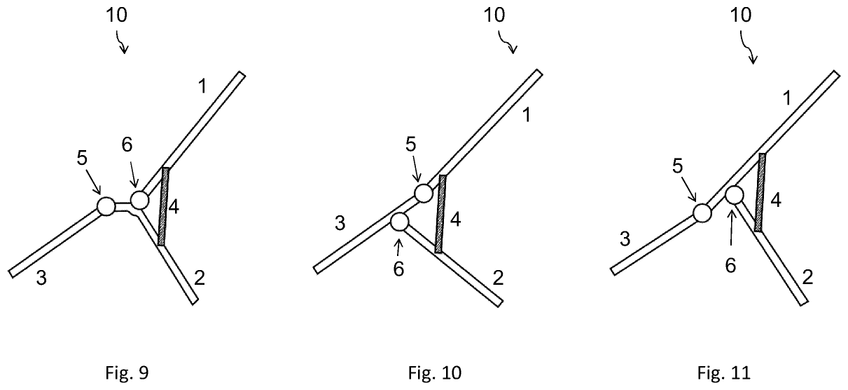

FIG. 9-FIG. 11 embodiments with two joints

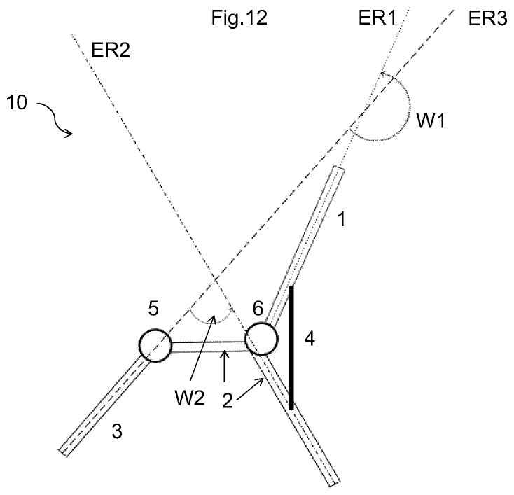

FIG. 12 an illustration of the angle determination

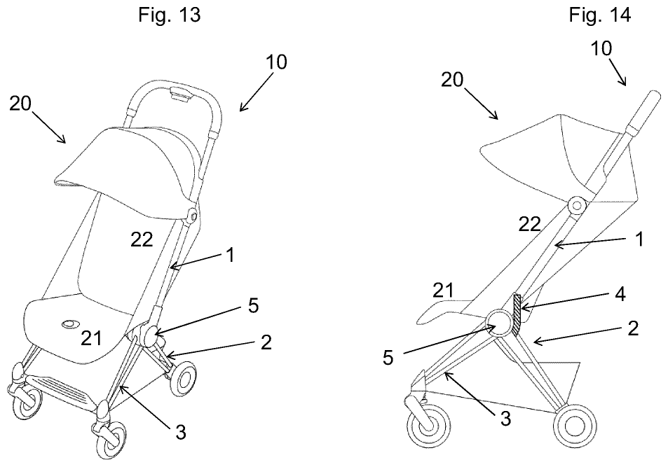

FIG. 13 a pram frame with a child accommodation unit

FIG. 14 a further view of the pram frame with child accommodation unit

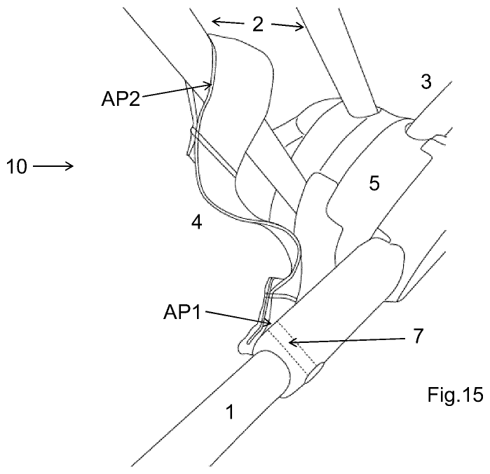

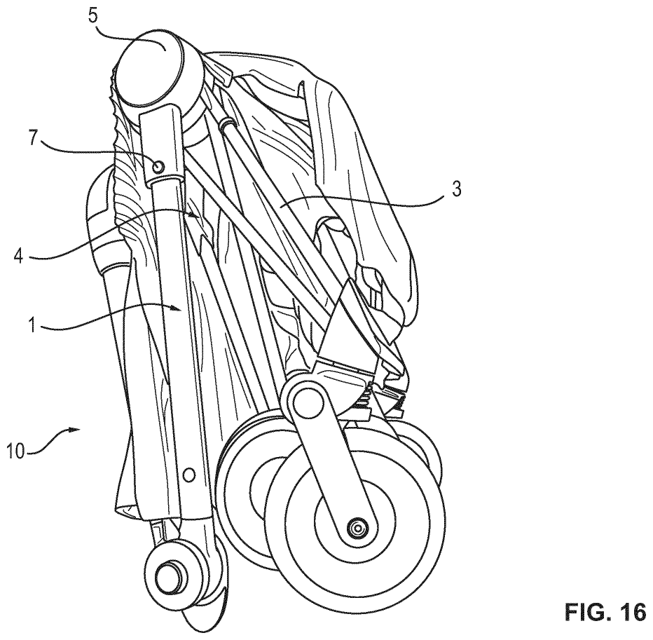

FIG. 15 a view of a first joint

FIG. 16 a further view of the pram frame with child accommodation unit

FIG. 1 shows a pram frame 10. In the embodiment shown, the pram frame 10 has a first joint 5, through which the third frame element 3, the first frame element 1 and the second frame element 2 are rotatably connected to each other. All frame elements can rotate about the axis defined by the first joint 5. The first frame element 1 and the second frame element 2 are coupled to each other via the pull element 4. In the Illustration shown, the pram frame 10 is in the usage position, which means that it is fully unfolded. As shown, wheels can be attached to the ends of the third and second frame elements 3, 2, which are not connected to each other via the first joint 5.

FIG. 2 shows components of a pram frame. In particular, FIG. 2 shows the first frame element 1, the second frame element 2, the third frame element 3 and the pull element 4.

FIG. 3 also shows an embodiment with only one first joint 5 in the storage position. The storage position is characterised in particular by the fact that all frame elements are folded up relatively close together. The dimensionally unstable pull element 4 can assume a sagging shape in this, which allows the first frame element 1 to move closer to the second frame element 2.

FIG. 4 shows the embodiment from FIG. 3 in a partially unfolded position, i.e., a position which is reached by moving the first frame element 1 in the first direction before the usage position is reached. As shown, the pull element is in a position that is in particular fully extended, between the first connection point AP1, at which the pull element 4 is connected to the first frame element 1, and the second connection point AP2, at which the pull element 4 is connected to the second frame element 2. Through this connection, the first frame element 1 exerts a force in the first direction on the second frame element 2 when it itself is moved in this direction. The length of the pull element 4 can result in the dead angle LW, which is an angle between the direction of extension of the second frame element 2 and the first frame element 1.

FIG. 5 shows a further stage of unfolding in a pram frame 10 with a first joint 5. Once the dead angle LW has been reached (or exceeded, if applicable), the first frame element 1 exerts a force on the second frame element 2 in the first direction, thereby moving it further. This causes the second frame element 2 to rotate about the axis defined by the first joint 5. This opens and enlarges a second angle W2, which is given by the angle between the direction of extension of the third frame element 3 and the direction of extension of the second frame element 2 about their point of intersection, measured in the first direction. In an embodiment with only one first joint 5, the point of intersection is typically the axis of said joint 5. In this, the first angle W1 is given by the angle between the direction of extension of the third frame element 3 and the first frame element 1, also in the first direction around the axis of the first joint 5. In the figure, the first direction points to the right, away from the third frame element 3 (counterclockwise). In a single-axis embodiment, such as the one shown here, it necessarily follows that the first angle W1 is the sum of the second angle W2 and the dead angle (not shown here).

FIG. 6 shows another embodiment example of the present invention with only one first joint 5. Again, the pram frame 10 is shown in the storage position.

FIG. 7 shows the embodiment from FIG. 6 when the dead angle LW is reached. One difference from FIGS. 3-5 is that the pull element 4 does not define the dead angle LW upon straight stretching, but is at least partially wrapped around the first joint 5. In addition, the first direction in the illustration shown now points to the left away from the third frame element 3 (clockwise).

FIG. 8 again shows another stage of unfolding, which follows on from the state shown in FIG. 7. Once again, due to the forced continued movement of the second frame element 2, a second angle W2 opens up as a result of the movement of the first frame element 1. The pull element 4, which can wrap around the first joint 5, can pull the second frame element 2 upwards to the left when the first frame element 1 is turned to the right. Once again, it can be seen that in a single-axis arrangement, the first angle W1 is the sum of the dead angle (not shown here) and the second angle W2.

In FIGS. 2-5, the first frame element can be regarded as a pusher, the second frame element as a rear wheel strut and the third frame element as a front wheel strut. In FIGS. 6-8, the first frame element can also be regarded as a pusher, the second frame element as a front wheel strut and the third frame element as a rear wheel strut.

The frame elements can generally be designed strut-like (as shown in FIGS. 2-8), but the disc shown at the respective proximal ends is only exemplary for the design of a joint and is not absolutely necessary.

FIG. 9 shows a further example embodiment of a pram frame 10, which has a first joint 5 and a second joint 6. In the embodiment shown, the second joint 6 is attached as a connection between the first frame element 1 and the second frame element 2.

FIG. 10 shows a further example embodiment with a first joint 5 and a second joint 6, wherein the second joint 6 forms a connection between the third frame element 3 and the second frame element 2.

FIG. 11 shows a further two-joint embodiment in which the second joint 6 connects the first frame element 1 and the second frame element 2 to each other.

FIG. 12 serves to Illustrate the determination of the first angle W1 and the second angle W2 in the more complicated situation of a two-joint pram frame. In such an embodiment, the frame elements do not all rotate about the axis defined by the first joint 5, but rather there is an overlap of rotations about the axis of the first joint 5 with rotations about the axis of the second joint 6. For better illustration, the first direction of extension ER1, the second direction of extension ER2 as well as the third direction of extension ER3 of the first, second and third frame elements 1, 2, 3 are explicitly drawn herein. The first angle W1 is determined from the angle of the first direction of extension ER1 to the third direction of extension ER3, around their point of intersection. Since the first angle W1 belongs to a rotation that is intended to describe the movement of the first frame element 1 in the first direction, a first angle W1 of more than 180° results as shown in the illustrated position. The second angle W2 results from the angle between the second direction of extension ER2 and the third direction of extension ER3 around their point of intersection, and is less than 90° in the illustrated position. In the case of a two-joint arrangement, the dead angle LW between the first and second frame elements 1, 2 (not shown here) does not necessarily result from the addition of the first and second angles W1, W2.

FIG. 13 shows a pram frame 10 with a child accommodation unit 20 comprising a buttock section designed as seat surface 21 and a back section designed as backrest 22. The child accommodation unit 20 is attached to the pram frame 10 in this and is together with the latter in the usage position.

FIG. 14 shows the pram frame 10 with the child accommodation unit 20 as shown in FIG. 13, from a side view. It can be seen how the pull element 4 is attached in the usage position in a state of maximum tension between the first frame element 1 and the second frame element 2.

FIG. 15 shows an enlarged view of the first joint 5 according to an embodiment. The second frame element 2 comprises two parallel running bars in this. The first frame element 1, the second frame element 2 and the third frame element 3 can herein again be rotated relative to each other about the axis of the first joint 5. The pull element 4, which connects the first frame element 1 to the second frame element 2, is attached here to the first frame element 1 at the first connection point AP1.

Shown is an arrangement in which the first connection point AP1 is fixedly attached to the first frame element 1 by a rivet 7. The second connection point AP2 is attached slidingly movable to the second frame element 2 in this. In the embodiment shown here, the slidingly movable attachment results from the use of a loop, which allows the second connection point AP2 to be displaceable along the direction of extension of the second frame element. In the embodiment shown, the rear wheel strut forms the second frame element 2, with the pusher forming the first frame element 1 and the front wheel strut forming the third frame element 3.

FIG. 16 shows a pram frame 10 in the storage position. The pull element 4 is connected to the first frame element 1 at the first connection point by a rivet 7 and to the second frame element by a loop.

It should be noted at this point that all the parts described above, viewed individually and in any combination, in particular the details shown in the drawings, are claimed as essential to the invention. Modifications thereof are familiar to those skilled in the art.

Furthermore, it is pointed out that a scope of protection as broad as possible is sought. In this respect, the disclosure contained in the claims may also be specified by features that are described with further features (even without these further features necessarily being included). It is explicitly pointed out that round brackets and the term ‘in particular’ are intended to emphasise the optional nature of features

In the respective context (which does not mean, conversely, that without such identification a feature is to be regarded as mandatory in the respective context). The term ‘element’ should preferably denote a coherent structure (or assembly group) which, in turn, may be connected to at least one other structure (to form a single-piece and/or in itself immovable overall structure) or may be delimited from all other structures.

At least FIGS. 13-16 also have aspects that are aesthetic in nature.

List of reference symbols

| | |
|---|---|
| first frame element | 1 |
| second frame element | 2 |
| third frame element | 3 |
| pull element | 4 |
| first angle | W1 |
| second angle | W2 |
| first direction of extension | ER1 |
| second direction of extension | ER2 |
| third direction of extension | ER3 |
| first connection point | AP1 |
| second connection point | AP2 |
| first joint | 5 |
| second joint | 6 |
| pram frame | 10 |
| child accommodation unit | 20 |
| seat surface | 21 |
| backrest | 22 |
| dead angle | LW |
| rivet | 7 |

1. A pram frame comprising: a first frame element, a second frame element, a third frame element and a pull element,
wherein the first, second and third frame elements are rotatably connected to each other and can be transferred between a usage position and a storage position by rotation,
wherein, during the transfer from the storage position to the usage position, the first frame element is moved relative to the third frame element in a first direction and sweeps over a first angular range, and the second frame element is also moved relative to the third frame element in the first direction and sweeps over a second angular range, wherein the second angular range is preferably smaller than the first angular range,
characterised in that the first frame element and the second frame element are connected to each other by the pull element and the first frame element drives the second frame element via the pull element to move in the first direction when the first frame element has reached or exceeded a dead angle relative to the second frame element.

2. The pram frame, in particular according to claim 1, comprising: a first frame element, a second frame element, a third frame element and a pull element,
wherein the first, second and third frame elements are rotatably connected to each other and can be transferred between a usage position and a storage position by rotation,
wherein, during the transfer from the storage position to the usage position, the first frame element is moved relative to the third frame element in a first direction and sweeps over a first angular range, and the second frame element is also moved relative to the third frame element in the first direction and sweeps over a second angular range, wherein the second angular range is preferably smaller than the first angular range,
wherein the first angular range is defined in particular as the region in which a first angle (W1) can lie during the transfer between storage position and usage position, and wherein the second angular range is defined in particular as the region in which a second angle can lie during the transfer between storage position and usage position,
wherein the first angle indicates the angle in the first direction between a third direction of extension of the third frame element and a first direction of extension of the first frame element around the point of intersection of the first and third directions of extension in a plane that is perpendicular to one or several axes about which the third frame element is rotatably connected to another frame element,
and wherein the second angle indicates the angle in the first direction between a third direction of extension of the third frame element and a second direction of extension of the second frame element around the point of intersection of the second and third directions of extension in a plane that is perpendicular to one or several axes about which the third frame element is rotatably connected to another frame element,
characterised in that the first frame element and the second frame element are connected to each other by the pull element and the first frame element drives the second frame element via the pull element to move in the first direction when the first frame element has reached or exceeded a dead angle relative to the second frame element.

3. The pram frame according to claim 1, wherein the pull element is connected at a first end to the first frame element at a first connection point (AP1) and at a second end to the second frame element at a second connection point.

4. The pram frame according to claim 1, wherein the pull element is designed to be dimensionally unstable, preferably as a strap, belt, chain or cord.

5. The pram frame according to claim 1, comprising a first joint at one end of the third frame element, wherein the first and/or second frame elements are connected to the third frame element in a manner that allows them to rotate about the first joint.

6. The pram frame according to claim 1, in particular according to claim 5, comprising a second joint which is attached to the first, second or third frame element in order to connect the first and second or second and third or first and third frame elements to each other in a rotatable manner, wherein the axis of rotation is parallel to the axis of rotation of the first joint.

7. The pram frame according to claim 1, in particular according to any one of claims 5 and 6, wherein the frame can be locked in the usage position and/or storage position, preferably by a first locking element within the first and/or second joint wherein the locking element is preferably in direct or indirect operative connection with an unlocking device.

8. The pram frame according to claim 1, in particular according to claim 7, wherein a locking is automatically triggered upon reaching the usage position and/or the storage position.

9. The pram frame according to claim 1, wherein at least the first and/or second and/or third frame elements may be selected from a front wheel strut, rear wheel strut and pusher section, wherein they are preferably selected in pairs different from each other.

10. The pram frame according to claim 1, comprising a child accommodation unit comprising a back section and a buttock section, wherein the back section is preferably rotatably connected to the buttock section and/or rotatably arranged relative to the buttock section, wherein the surfaces of the back section and the buttock section which come into contact with a child accommodated in the child accommodation unit preferably abut against each other or face each other in the storage position, in particular at an angle between the surfaces of at least 2° and/or at maximum 50°.

11. The pram frame according to claim 1, wherein the child accommodation unit is connected to the pram frame in such a way that the child accommodation unit is transferred from the usage position to the storage position at the same time as the pram frame.

12. The pram frame according to claim 1, wherein the second angular range during the transfer from the storage position to the usage position by rotating and/or swivelling the first frame element is at least 0.2 times and/or at most 0.8 times the first angular range, preferably at least 0.3 times and/or at most 0.7 times, more preferably at least 0.4 times and/or at most 0.6 times.

13. The pram frame according to claim 1, wherein the first angular range can be 140°-220°, preferably 160°-200°, more preferably 110°-240°, in particular 170°-190°.

14. A method for transferring a pram chassis from a storage position to a usage position according to claim 1, wherein the first frame element is rotated and/or tilted relative to the third frame element, wherein, after the first frame element has reached or exceeded the dead angle, the second frame element is pulled in the first direction via the pull element.
